(19) United States
(12) Patent Application Publication
(10) Pub. No.: US 2017/0046995 A1
(43) Pub. Date: Feb. 16, 2017

(54) GAMMA CURVE ADJUSTING METHOD AND DEVICE

(71) Applicant: BOE TECHNOLOGY GROUP CO., LTD., Beijing (CN)

(72) Inventors: Yi CHEN, Beijing (CN); Guangcai YUAN, Beijing (CN)

(21) Appl. No.: 15/160,572

(22) Filed: May 20, 2016

(30) Foreign Application Priority Data
Aug. 14, 2015 (CN) 201510501990.1

(51) Int. Cl. G09G 3/20

(52) U.S. Cl. CPC G09G 3/2003; G09G 2320/0673; G09G 2320/0271; G09G 2320/0233; G09G 2360/16

(57) ABSTRACT

The present disclosure provides gamma curve adjusting method and device, and the method includes: substituting a preset maximum brightness value, a preset gamma value and gray-scale values into a standard gamma curve calculation formula, to obtain brightness values corresponding to the gray-scale values; selecting N gray-scale values from the gray-scale values, and actually measuring, in the condition of the selected N gray-scale values, gray-scale voltage values required to reach brightness values, respectively corresponding to the selected N gray-scale values, calculated according to the standard gamma curve calculation formula, where N is a positive integer; obtaining a function formula between gray-scale voltage value and brightness value according to brightness values respectively corresponding to the selected N gray-scale values and the actually measured gray-scale voltage values; and calculating gray-scale voltage values corresponding to brightness values smaller than or equal to the preset maximum brightness value, according to the obtained function formula.

### FIELD OF THE INVENTION

The present invention relates to the field of display technology, and particularly to a gamma curve adjusting method and a gamma curve adjusting device.

### BACKGROUND OF THE INVENTION

Every display product has a gamma value. In terms of white organic light emitting diode (WOLED) display panels, the gamma value of each display panel may vary as color coordinates or electroluminescent efficiency thereof varies. Moreover, as the usage time of the display panel increases, an electroluminescent device is aged, and electroluminescent efficiency thereof decreases accordingly, thereby resulting in a change in the gamma value.

Currently, a large-size light emitting diode display panel generally has a structure in which a white light emitting diode cooperates with a color filter. White balancing is needed before adjusting the gamma value, and the gamma value for each of red (R), green (G), blue (B), and white (W) colors needs to be adjusted separately.

At present, gamma curve adjustment is achieved by actually measuring voltage values required when each of nine points with known gray-scales (specified by IC spec) reaches a desired brightness corresponding thereto. Therefore, for each display panel, it is necessary to measure gray-scale voltage values of 36 (=(RGBW)4*9) points in total. In addition, in order to cope with changes in data voltage, multiple groups of gamma values may need to be set before a light emitting diode display panel leaves the factory, for example. Gamma2 (i.e., gamma value of 2), Gamma2.2 (i.e., gamma value of 2.2). Gamma2.4 (i.e., gamma value of 2.4) and the like are set for each of brightness of 100 nit and brightness of 150 nit. For each group of gamma values, 36 points need to be measured, and thus it takes a lot of time to test multiple groups of gamma values, which makes it difficult to meet the deadlines of mass production.

### SUMMARY OF THE INVENTION

An object of the present invention is to provide a gamma curve adjusting method and a gamma curve adjusting device to adjust gamma curve quickly.

In order to achieve the above object, as a first aspect of the present invention, there is provided a gamma curve adjusting method, including steps of:

substituting a preset maximum brightness value, a preset gamma value and gray-scale values into a standard gamma curve calculation formula, to obtain brightness values corresponding to the gray-scale values;

selecting N gray-scale values from the gray-scale values, and actually measuring, in the condition of the selected N gray-scale values, gray-scale voltage values required to reach brightness values, respectively corresponding to the selected N gray-scale values, calculated according to the standard gamma curve calculation formula, where N is a positive integer;

obtaining a function formula between gray-scale voltage value and brightness value according to the brightness values respectively corresponding to the selected N gray-scale values and the actually measured gray-scale voltage values; and

calculating the gray-scale voltage values corresponding to brightness values smaller than or equal to the preset maximum brightness value, according to the obtained function formula.

Optionally, the standard gamma curve calculation formula is:

$${L}_{Gray} = {{L}_{max} ( \frac{Gray}{{N}_{{Gray}_{—} max}} )}^{γ} ;$$

where, N_{gray}_{_}ₘₐₓ is the maximum gray-scale value, Gray is any gray-scale value in the range of [0, N_{gray}_{_}ₘₐₓ], γ is the preset gamma value, Lₘₐₓ is the preset maximum brightness value, and L_{Gray} is the brightness value corresponding to the gray-scale value Gray.

Optionally, the step of obtaining a function formula between gray-scale voltage value and brightness value according to the brightness values respectively corresponding to the selected N gray-scale values and the actually measured gray-scale voltage values includes:

sequentially selecting two adjacent gray-scale values from the N selected gray-scale values and performing spline fitting on the brightness values and the gray-scale voltage values corresponding to the two adjacent gray-scale values, to obtain (N−1) function formulas; and

the step of calculating the gray-scale voltage values corresponding to brightness values smaller than or equal to the preset maximum brightness value, according to the obtained function formula includes:

calculating the gray-scale voltage values corresponding to the brightness values between two brightness values respectively corresponding to the two adjacent gray-scale values, according to the function formula obtained by performing spline fitting on the brightness values and the gray-scale voltage values corresponding to the two adjacent gray-scale values.

Optionally, the (N−1) function formulas each are a cubic function formula, and the cubic function formula obtained by performing fitting on the brightness values and the gray-scale voltage values corresponding to the n-th selected gray-scale value and the (n+1)-th selected gray-scale value is:

V=a₁ₙ(L−Lₙ)³+a₂ₙ(L−Lₙ)²+a₃ₙ(L−Lₙ)+Vₙ;

where, nε[1, N−1], L is a brightness value in the range of [Lₙ, Lₙ₊₁], Lₙ is the brightness value corresponding to the n-th selected gray-scale value, Lₙ₊₁ is the brightness value corresponding to the (n+1)-th selected gray-scale value, Vₙ is the gray-scale voltage value corresponding to the brightness value Lₙ, V is the gray-scale voltage value corresponding to the brightness value L, and a₁ₙ, a₂ₙ and a₃ₙ are fitting coefficients; and

as for the brightness value in the range of [Lₙ, Lₙ₊₁], the gray-scale voltage value corresponding thereto is calculated according to the cubic function formula.

Optionally, N≧9.

Optionally, N=9;

the cubic function formula obtained by performing fitting on the brightness values and the gray-scale voltage values corresponding to the first and second selected gray-scale values is:

V=a₁₁(L−L₁)³+a₂₁(L−L₁)²+a₃₁(L−L₁)+V₁ (1-1)

as for the brightness value L in the range of [L₁, L₂], the gray-scale voltage value V corresponding thereto is calculated according to the cubic function formula (1-1), where L₁ and L₂ are the brightness values corresponding to the first and second selected gray-scale values, respectively, V₁ is the gray-scale voltage value corresponding to the first selected gray-scale value, and a₁₁, a₂₁ and a₃₁ are fitting coefficients of the cubic function formula (1-1);

the cubic function formula obtained by performing fitting on the brightness values and the gray-scale voltage values corresponding to the second and third selected gray-scale values is:

V=a₁₂(L−L₂)³+a₂₂(L−L)²+a₃₂(L−L₂)+V₂ (1-2)

as for the brightness value L in the range of [L₂, L₃], the gray-scale voltage value V corresponding thereto is calculated according to the cubic function formula (1-2), where L₂ and L₃ are the brightness values corresponding to the second and third selected gray-scale values, respectively, V₂ is the gray-scale voltage value corresponding to the second selected gray-scale value, and a₁₂, a₂₂ and a₃₂ are fitting coefficients of the cubic function formula (1-2);

the cubic function formula obtained by performing fitting on the brightness values and the gray-scale voltage values corresponding to the third and fourth selected gray-scale values is:

V=a₁₃(L−L₃)³+a₂₃(L−L₃)²+a₃₃(L−L₃)+V₃ (1-3)

as for the brightness value L in the range of [L₃, L₄], the gray-scale voltage value V corresponding thereto is calculated according to the cubic function formula (1-3), where L₃ and L₄ are the brightness values corresponding to the third and fourth selected gray-scale values, respectively, V₃ is the gray-scale voltage value corresponding to the third selected gray-scale value, and a₁₃, a₂₃, and a₃₃ are fitting coefficients of the cubic function formula (1-3);

the cubic function formula obtained by performing fitting on the brightness values and the gray-scale voltage values corresponding to the fourth and fifth selected gray-scale values is:

V=a₁₄(L−L₄)³+a₂₄(L−L₄)²+a₃₄(L−L₄)+V₄ (1-4)

as for the brightness value L in the range of [L₄, L₅], the gray-scale voltage value V corresponding thereto is calculated according to the cubic function formula (1-4), where L₄ and L, are the brightness values corresponding to the fourth and fifth selected gray-scale values, respectively, V₄ is the gray-scale voltage value corresponding to the fourth selected gray-scale value, and a₁₄, a₂₄ and a₃₄ are fitting coefficients of the cubic function formula (1-4);

the cubic function formula obtained by performing fitting on the brightness values and the gray-scale voltage values corresponding to the fifth and sixth selected gray-scale values is:

V=a₁₅(L−L₅)³+a₂₅(L−L₅)²+a₃₅(L−L₅)+V₅ (1-5)

as for the brightness value L in the range of [L₅, L₆], the gray-scale voltage value V corresponding thereto is calculated according to the cubic function formula (1-5), where L₅ and L₆ are the brightness values corresponding to the fifth and sixth selected gray-scale values, respectively, V₅ is the gray-scale voltage value corresponding to the fifth selected gray-scale value, and a₁₅, a₂₅ and a₃₅ are fitting coefficients of the cubic function formula (1-5):

the cubic function formula obtained by performing fitting on the brightness values and the gray-scale voltage values corresponding to the sixth and seventh selected gray-scale values is:

V=a₁₆(L−L₆)³+a₂₆(L−L₆)²+a₃₆(L−L₆)+V₆ (1-6)

as for the brightness value L in the range of [L₆, L₇], the gray-scale voltage value V corresponding thereto is calculated according to the cubic function formula (1-6), where L₆ and L₇ are the brightness values corresponding to the sixth and seventh selected gray-scale values, respectively, V₆ is the gray-scale voltage value corresponding to the sixth selected gray-scale value, and a₁₆, a₂₆ and a₃₆ are fitting coefficients of the cubic function formula (1-6):

the cubic function formula obtained by performing fitting on the brightness values and the gray-scale voltage values corresponding to the seventh and eighth selected gray-scale values is:

V=a₁₇(L−L₇)³+a₂₇(L−L₇)²+a₃₇(L−L₇)+V₇ (1-7)

as for the brightness value L in the range of [L₇, L₈], the gray-scale voltage value V corresponding thereto is calculated according to the cubic function formula (1-7), where L₇ and L₈ are the brightness values corresponding to the seventh and eighth selected gray-scale values, respectively, V₇ is the gray-scale voltage value corresponding to the seventh selected gray-scale value, and a₁₇, a₂₇ and a₃₇ are fitting coefficients of cubic function the formula (1-7); and

the cubic function formula obtained by performing fitting on the brightness values and the gray-scale voltage values corresponding to the eighth and ninth selected gray-scale values is:

V=a₁₈(L−L₈)³+a₂₈(L−L₈)²+a₃₈(L−L₈)+V₈ (1-8)

as for the brightness value L in the range of [L₈, L₉], the gray-scale voltage value V corresponding thereto is calculated according to the cubic function formula (1-8), where L₈ and L₉ are the brightness values corresponding to the eighth and ninth selected gray-scale values, respectively, V₈ is the gray-scale voltage value corresponding to the eighth selected gray-scale value, and a₁₈, a₂₈ and a₃₈ are fitting coefficients of the cubic function formula (1-8).

As a second aspect of the present invention, there is provided a gamma curve adjusting device, including:

a standard brightness calculation module, used for substituting a preset maximum brightness value, a preset gamma value and gray-scale values into a standard gamma curve calculation formula, to obtain brightness values corresponding to the gray-scale values;

a gray-scale voltage measuring module, used for selecting N gray-scale values from the gray-scale values, and actually measuring, in the condition of the selected N gray-scale values, gray-scale voltage values required to reach the brightness values, respectively corresponding to the selected N gray-scale values, calculated by the standard brightness calculation module, where N is a positive integer;

a data fitting module, used for obtaining a function formula between gray-scale voltage value and brightness value according to the brightness values respectively corresponding to the selected N gray-scale values and the gray-scale voltage values actually measured by the gray-scale voltage measuring module; and

a gray-scale voltage calculation module, used for calculating the gray-scale voltage values corresponding to brightness values smaller than or equal to the preset maximum brightness value, according to the function formula obtained by the data fitting module.

Optionally, wherein, the standard brightness calculation module calculates the brightness values corresponding to the gray-scale values according to the following standard gamma curve calculation formula:

$${L}_{Gray} = {{L}_{max} ( \frac{Gray}{{N}_{{Gray}_{—} max}} )}^{γ}$$

where, N_{gray}_{_}ₘₐₓ is the maximum gray-scale value, Gray is any gray-scale value in the range of [0, N_{gray}_{_}ₘₐₓ], γ is the preset gamma value, Lₘₐₓ is the preset maximum brightness value, and L_{Gray} is the brightness value corresponding to the gray-scale value Gray.

Optionally, the data fitting module sequentially selects two adjacent gray-scale values from the N selected gray-scale values and performs spline fitting on the brightness values and the gray-scale voltage values corresponding to the two adjacent gray-scale values, to obtain (N−1) function formulas; and

the gray-scale voltage calculation module calculates the gray-scale voltage values corresponding to the brightness values between two brightness values respectively corresponding to the two adjacent gray-scale values, according to the function formula obtained by performing spline fitting on the brightness values and the gray-scale voltage values corresponding to the two adjacent gray-scale values.

Optionally, the (N−1) function formulas each are a cubic function formula, and the cubic function formula obtained by performing fitting on the brightness values and the gray-scale voltage values corresponding to the n-th selected gray-scale value and the (n+1)-th selected gray-scale value is:

V=a₁ₙ(L−Lₙ)³+a₂ₙ(L−Lₙ)²+a₃ₙ(L−Lₙ)+Vₙ;

where, nε[1, N−1], L is a brightness value in the range of [Lₙ, Lₙ₊₁], Lₙ is the brightness value corresponding to the n-th selected gray-scale value, Lₙ₊₁ is the brightness value corresponding to the (n+1)-th selected gray-scale value, Vₙ is the gray-scale voltage value corresponding to the brightness value Lₙ, V is the gray-scale voltage value corresponding to the brightness value L, and a₁ₙ, a₂ₙ and a₃ₙ are fitting coefficients; and

as for the brightness value L in the range of [Lₙ, Lₙ₊₁], the gray-scale voltage value V corresponding thereto is calculated by the gray-scale voltage calculation module according to the cubic function formula.

In the present disclosure, by actually measuring, in the condition of the given maximum brightness value, the gray-scale voltage values corresponding to a set of brightness values, and performing data fitting, the function formula between gray-scale voltage value and brightness value is obtained, so that the gray-scale voltage values corresponding to other brightness values smaller than or equal to the given maximum brightness value can be obtained by using the function formula. Therefore, in the preset disclosure, the time for gamma curve adjustment is significantly shortened while gray-scale voltage accuracy is ensured, and thus production efficiency is improved.

### BRIEF DESCRIPTION OF THE DRAWINGS

The accompanying drawings, which serve to provide a further understanding of the present invention and constitute a part of this specification, are used for explaining the present invention together with the following specific implementations, rather than limiting the present invention.

FIG. 1 is a flowchart of a gamma curve adjusting method according to embodiments of the present invention;

FIGS. 2a to 2d are schematic diagrams illustrating a process of adjusting a gamma curve by using a gamma curve adjusting method according to embodiments of the present invention; and

FIG. 3 is a block diagram of a gamma curve adjusting device according to embodiments of the present invention.

### DETAILED DESCRIPTION OF THE EMBODIMENTS

Specific embodiments of the present invention will be described in detail below in conjunction with the accompanying drawings. It should be understood that, the specific embodiments described herein are merely used for explaining and describing the present invention, rather than limiting the present invention.

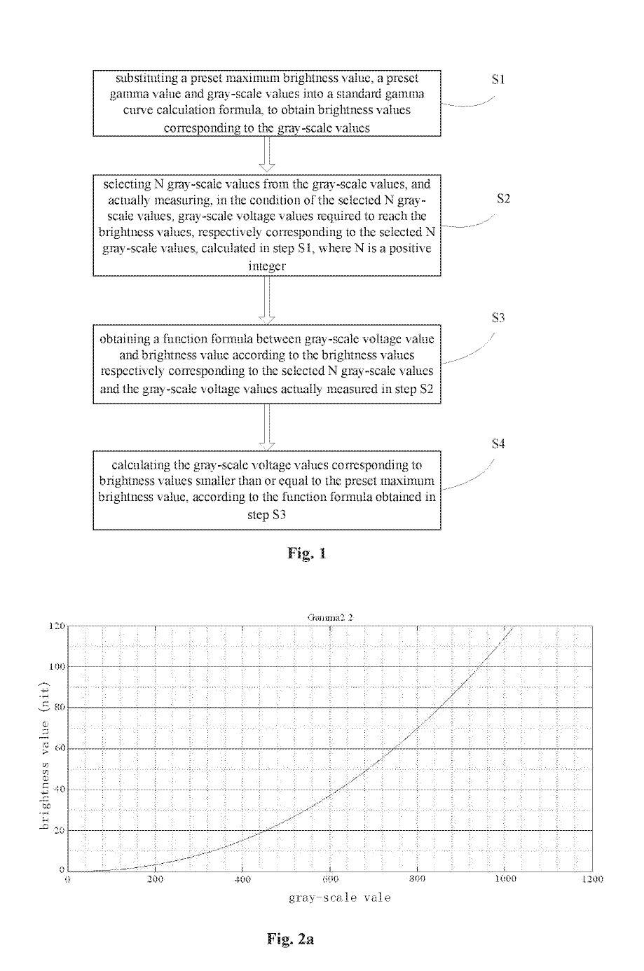

Embodiments of the present invention provide a gamma curve adjusting method, which, as shown in FIG. 1, includes steps of:

S1, substituting a preset maximum brightness value, a preset gamma value and gray-scale values into a standard gamma curve calculation formula, to obtain brightness values corresponding to the gray-scale values:

S2, selecting N gray-scale values from the gray-scale values, and actually measuring, in the condition of the selected N gray-scale values, gray-scale voltage values required to reach brightness values, respectively corresponding to the selected N gray-scale values, calculated in step S1, where N is a positive integer;

S3, obtaining a function formula between gray-scale voltage value and brightness value according to the brightness values respectively corresponding to the selected N gray-scale values and the gray-scale voltage values actually measured in step S2; and

S4, calculating the gray-scale voltage values corresponding to brightness values smaller than or equal to the preset maximum brightness value, according to the function formula obtained in step S3.

In general, multiple groups of gamma values (for example, Gamma2, Gamma2.2, Gamma2.4, and the like) need to be set for multiple maximum brightness values (for example, 100 nit, 120 nit, 150 nit, and the like) before a display product leaves the factory, resulting in that it takes a lot of time to perform gamma curve adjustment during production, and thus it is difficult to meet the deadlines of mass production.

In the embodiments of the present invention, by actually measuring, in the condition of the given maximum brightness value, the gray-scale voltage values corresponding to a set of brightness values (i.e., the brightness values corresponding to the selected set of gray-scale values), and performing data fitting, the function formula between gray-scale voltage value and brightness value is obtained, so that the gray-scale voltage values corresponding to any brightness values smaller than or equal to the given maximum brightness value can be obtained by using the function formula. Therefore, with the gamma curve adjusting method according to the embodiments of the present invention, the time for gamma curve adjustment is significantly shortened while gray-scale voltage accuracy is ensured, and thus production efficiency is improved.

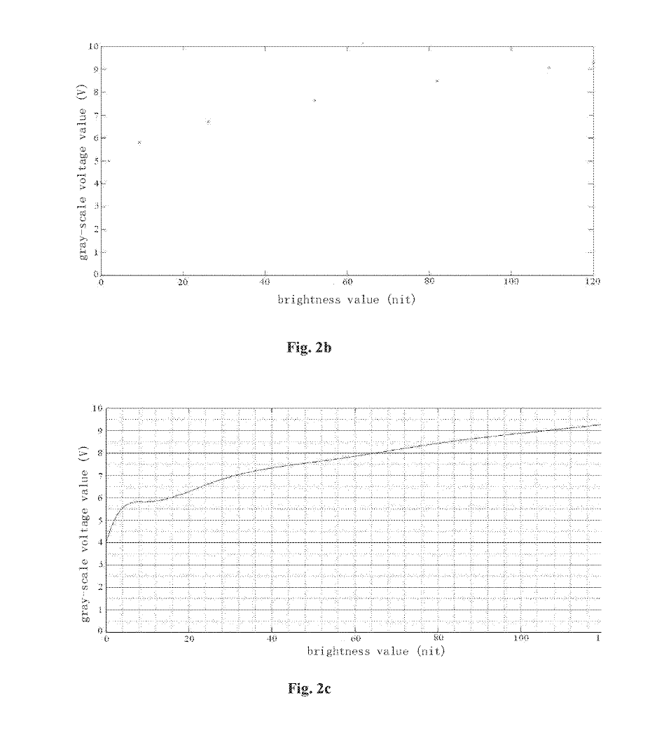

FIGS. 2a to 2d are schematic diagrams illustrating an exemplary process of adjusting a gamma curve by a gamma curve adjusting method according to embodiments of the present invention. In the example shown in FIGS. 2a to 2d, description is given by taking the case that the preset maximum brightness value is 120 nit and the preset gamma value is 2.2 as an example.

FIG. 2a illustrates a standard gamma curve in the case that the maximum brightness value is 120 nit and the gamma value is 2.2. In step S1, brightness values corresponding to the gray-scale values can be calculated according to the standard gamma curve illustrated in FIG. 2a.

Subsequently, in step S2, a set of gray-scale values are selected from all of the gray-scale values, gray-scale voltage values required by a tested panel to reach brightness values calculated according to the standard gamma curve illustrated in FIG. 2a are actually measured in the condition of the selected gray-scale values, and FIG. 2b illustrates the brightness values and the gray-scale voltage values corresponding to the selected gray-scale values in the form of coordinate points.

FIG. 2c illustrates a function curve obtained, in step S3, by performing fitting on the coordinate points in FIG. 2b, and the gray-scale voltage value corresponding to any brightness value smaller than or equal to 120 nit can be obtained according to the function curve in FIG. 2c. FIG. 2d is a diagram illustrating gray-scale voltage values corresponding to brightness values smaller than or equal to 100 nit obtained according to the function curve illustrated in FIG. 2c, in step S4.

Specifically, in step S1, the standard gamma curve calculation formula is:

$${L}_{Gray} = {{L}_{max} ( \frac{Gray}{{N}_{{Gray}_{—} max}} )}^{γ} ;$$

where, N_{gray}_{_}ₘₐₓ is the maximum gray-scale value, Gray is any gray-scale value in the range of [0, N_{gray}_{_}ₘₐₓ], γ is the preset gamma value, Lₘₐₓ is the preset maximum brightness value, and L_{Gray} is the brightness value corresponding to the gray-scale value Gray.

For example, when the total number of gray-scales is 1024, the preset maximum brightness value is 120 nit, and the present gamma value is 2.2, the maximum gray-scale value N_{gray}_{_}ₘₐₓ is 1023, and the corresponding standard gamma curve calculation formula is:

$${L}_{Gray} = 120 {( \frac{Gray}{1023} )}^{2.2} ;$$

where, Gray is any gray-scale value in the range of [0, 1023].

In general, it is quite difficult to realize the above standard gamma curve exactly in a circuit, and an existing method is to select some gray-scale values (generally specified by IC spec) from the above standard gamma curve, and then to adjust the gray-scale voltages corresponding to these selected gray-scale values such that the brightness values corresponding to these selected gray-scale values reach the desired brightness values calculated according to the standard gamma curve.

In actual test, N is generally greater than or equal to 9. That is to say, the number of the selected gray-scale values is preferably greater than or equal to 9, for example, N may equal to 9, 12, 15, or the like. Within a certain range, the greater N, the higher subsequent fitting accuracy, and the better fitting effect.

According to the embodiments of the present invention, a looking up table may be created according to the selected gray-scale values, and the brightness values and the gray-scale voltage values corresponding to the selected gray-scale values. Table 1 below illustrates an example of the looking up table of nine selected gray-scale values and the brightness values and the gray-scale voltage values corresponding to the nine selected gray-scale values in the case of N=9, in which G₁˜G₉ represent the selected gray-scale values, L₁˜L₉ represent desired brightness values corresponding to the selected gray-scale values G₁˜G₉ and calculated according to the standard gamma curve, and V₁˜V₉ represent gray-scale voltage values required to reach the desired brightness values L₁˜L₉ in the condition of the selected gray-scale values G₁˜G₉.

TABLE I

| selected gray-scale value | G₁ | G₂ | G₃ | G₄ | G₅ | G₆ | G₇ | G₈ | G₉ |
|---|---|---|---|---|---|---|---|---|---|
| brightness value | L₁ | L₂ | L₃ | L₄ | L₅ | L₆ | L₇ | L₈ | L₉ |
| gray-scale voltage value | V₁ | V₂ | V₃ | V₄ | V₅ | V₆ | V₇ | V₈ | V₉ |

Further, step S3 may specifically include:

sequentially selecting two adjacent gray-scale values from the N selected gray-scale values and performing spline fitting on the brightness values and the gray-scale voltage values corresponding to the two adjacent gray-scale values, to obtain (N−1) function formulas.

As an example, data pairs (L₁, V₁) and (L₂, V₂) are selected from the data shown in Table 1 to perform spline fitting to obtain a first function formula, data pairs (L₂, V₂) and (L₃, V₃) are selected to perform spline fitting to obtain a second function formula, and so on, and finally, data pairs (L₈, V₈) and (L₉, V₉) are selected to perform spline fitting to obtain an eighth function formula.

In the embodiments of the present invention, the term “performing spline fitting” means performing fitting on two adjacent data pairs by using spline algorithm. Compared with the case where fitting is performed on multiple data pairs simultaneously to obtain one curve, sequentially performing spline fitting on two adjacent data pairs can improve fitting accuracy, and thus ensure accuracy of the gray-scale voltage adjustment to the greatest extent.

Accordingly, step S4 may specifically include:

calculating the gray-scale voltage values corresponding to the brightness values between two brightness values respectively corresponding to the two adjacent gray-scale values, according to the function formula obtained by performing spline fitting on the brightness values and the gray-scale voltage values corresponding to the selected two adjacent gray-scale values.

As an example, as for a brightness value between L₁ and L₂, the gray-scale voltage value corresponding thereto is calculated according to the first function formula obtained by performing spline fitting on the data pairs (L₁, V₁) and (L₂, V₂); as for the brightness value between L₂ and L₃, the gray-scale voltage value corresponding thereto is calculated according to the second function formula obtained by performing spline fitting on the data pairs (L₂, V₂) and (L₃, V₃), and so on.

Optionally, in step S3, the (N−1) function formulas may each be a cubic function formula, and the cubic function formula obtained by performing fitting on the brightness values and the gray-scale voltage values corresponding to the n-th selected gray-scale value and the (n+1)-th selected gray-scale value is:

V=a₁ₙ(L−Lₙ)³+a₂ₙ(L−Lₙ)²+a₃ₙ(L−Lₙ)+Vₙ;

where, nε[1, N−1], L is a brightness value in the range of [Lₙ, Lₙ₊₁], Lₙ is the brightness value corresponding to the n-th selected gray-scale value, Lₙ₊₁ is the brightness value corresponding to the (n+1)-th selected gray-scale value. Vₙ is the gray-scale voltage value corresponding to the brightness value Lₙ, V is the gray-scale voltage value corresponding to the brightness value L, and a₁ₙ, a₂ₙ and a₃ₙ are fitting coefficients.

Accordingly, in step S4, as for the brightness value L in the range of [Lₙ, Lₙ₊₁], the gray-scale voltage value V corresponding thereto is calculated according to the above cubic function formula.

The cubic function formula obtained by fitting is explained by taking the case of N=9 as an example below.

The cubic function formula obtained by performing fitting on the brightness values and the gray-scale voltage values corresponding to the first and second selected gray-scale values is:

V=a₁₁(L−L₁)³+a₂₁(L−L₁)²+a₃₁(L−L₁)+V₁ (1-1)

as for the brightness value L in the range of [L₁, L₂], the gray-scale voltage value V corresponding thereto may be calculated according to the formula (1-1), where L₁ and L₂ are the brightness values corresponding to the first and second selected gray-scale values, respectively, V₁ is the gray-scale voltage value corresponding to the first selected gray-scale value, and a₁₁, a₂₁ and a₃₁ are fitting coefficients of the formula (1-1).

The cubic function formula obtained by performing fitting on the brightness values and the gray-scale voltage values corresponding to the second and third selected gray-scale values is:

V=a₁₂(L−L₂)³+a₂₂(L−L₂)²+a₃₂(L−L₂)+V₂ (1-2)

as for the brightness value L in the range of [L₂, L₃], the gray-scale voltage value V corresponding thereto may be calculated according to the formula (1-2), where L₂ and L₃ are the brightness values corresponding to the second and third selected gray-scale values, respectively, V₂ is the gray-scale voltage value corresponding to the second selected gray-scale value, and a₁₂, a₂₂ and a₃₂ are fitting coefficients of the formula (1-2).

The cubic function formula obtained by performing fitting on the brightness values and the gray-scale voltage values corresponding to the third and fourth selected gray-scale values is:

V=a₁₃(L−L₃)³+a₂₃(L−L₃)²+a₃₃(L−L₃)+V₃ (1-3)

as for the brightness value L in the range of [L₃, L₄], the gray-scale voltage value V corresponding thereto may be calculated according to the formula (1-3), where L₃ and L₄ are the brightness values corresponding to the third and fourth selected gray-scale values, respectively, V₃ is the gray-scale voltage value corresponding to the third selected gray-scale value, and a₁₃, a₂₃ and a₃₃ are fitting coefficients of the formula (1-3).

The cubic function formula obtained by performing fitting on the brightness values and the gray-scale voltage values corresponding to the fourth and fifth selected gray-scale values is:

V=a₁₄(L−L₄)³+a₂₄(L−L₄)²+a₃₄(L−L₄)+V₄ (1-4)

as for the brightness value L in the range of [L₄, L₅], the gray-scale voltage value V corresponding thereto may be calculated according to the formula (1-4), where L₄ and L₅ are the brightness values corresponding to the fourth and fifth selected gray-scale values, respectively, V₄ is the gray-scale voltage value corresponding to the fourth selected gray-scale value, and a₁₄, a₂₄ and a₃₄ are fitting coefficients of the formula (1-4).

The cubic function formula obtained by performing fitting on the brightness values and the gray-scale voltage values corresponding to the fifth and sixth selected gray-scale values is:

V=a₁₅(L−L₅)³+a₂₅(L−L₅)²+a₃₅(L−L₅)+V₅ (1-5)

as for the brightness value L in the range of [L₅, L₆], the gray-scale voltage value V corresponding thereto may be calculated according to the formula (1-5), where L₅ and L₆ are the brightness values corresponding to the fifth and sixth selected gray-scale values, respectively, V₅ is the gray-scale voltage value corresponding to the fifth selected gray-scale value, and a₁₅, a₂₅ and a₃₅ are fitting coefficients of the formula (1-5).

The cubic function formula obtained by performing fitting on the brightness values and the gray-scale voltage values corresponding to the sixth and seventh selected gray-scale values is:

V=a₁₆(L−L₆)³+a₂₆(L−L₆)²+a₃₆(L−L₆)+V₆ (1-6)

as for the brightness value L in the range of [L₆, L₇], the gray-scale voltage value V corresponding thereto may be calculated according to the formula (1-6), where L₆ and L₇ are the brightness values corresponding to the sixth and seventh selected gray-scale values, respectively, V₆ is the gray-scale voltage value corresponding to the sixth selected gray-scale value, and a₁₆, a₂₆ and a₃₆ are fitting coefficients of the formula (1-6).

The cubic function formula obtained by performing fitting on the brightness values and the gray-scale voltage values corresponding to the seventh and eighth selected gray-scale values is:

V=a₁₇(L−L₇)³+a₂₇(L−L₇)²+a₃₇(L−L₇)+V₇ (1-7)

as for the brightness value L in the range of [L₇, L₈], the gray-scale voltage value V corresponding thereto may be calculated according to the formula (1-7), where L₇ and L₈ are the brightness values corresponding to the seventh and eighth selected gray-scale values, respectively, V₇ is the gray-scale voltage value corresponding to the seventh selected gray-scale value, and a₁₇, a₂₇ and a₃₇ are fitting coefficients of the formula (1-7).

The cubic function formula obtained by performing fitting on the brightness values and the gray-scale voltage values corresponding to the eighth and ninth selected gray-scale values is:

V=a₁₈(L−L₈)³+a₂₈(L−L₈)²+a₃₈(L−L₈)+V₈ (1-8)

as for the brightness value L in the range of [L₈, L₉], the gray-scale voltage value V corresponding thereto may be calculated according to the formula (1-8), where L₈ and L₉ are the brightness values corresponding to the eighth and ninth selected gray-scale values, respectively, V₈ is the gray-scale voltage value corresponding to the eighth selected gray-scale value, and a₁₈, a₂₈ and a₃₈ are fitting coefficients of the formula (1-8).

According to the above eight function formulas of (1-1) to (1-8), a curvilinear relationship between all the brightness values smaller than or equal to the preset maximum brightness value (120 nit) and the gray-scale voltage values can be established for the tested panel, so that other sets of gray-scale voltages corresponding to the brightness values smaller than 120 nit can be obtained according to the above function formulas, thereby achieving the object of adjusting the gamma curve quickly.

The gamma curve adjusting method according to the embodiments of the present invention will be described in detail below by way of a specific example.

It is assumed that the preset maximum brightness value is 120 nit, the preset gamma value is 2.2, the total number of gray-scales is 1024, and the number N of the selected gray-scale values is 9. As described above, the standard gamma curve calculation formula is:

$${L}_{Gray} = 120 {( \frac{Gray}{1023} )}^{2.2} .$$

Desired brightness corresponding to nine selected gray-scale values (specifically, 0, 40, 160, 320, 512, 700, 860, 980, and 1023) are calculated according to the above standard gamma curve calculation formula, as shown in Table 2. In Table 2, G represents selected gray-scale value, and L presents brightness value in (nit).

TABLE 2

| G | 0 | 40 | 160 | 320 | 512 | 700 | 860 | 980 | 1023 |
|---|---|---|---|---|---|---|---|---|---|
| L | 0 | 0.096 | 2.21 | 9.31 | 26.17 | 52.08 | 81.91 | 109.18 | 120 |

Afterwards, in the condition of the above nine selected gray-scale values, gray-scale voltage values required by the tested panel to reach the corresponding desired brightness values in Table 2 are actually measured to obtain a looking-up table shown in Table 3. In Table 3, G represents selected gray-scale value, L represents brightness value in (nit), and V represents gray-scale voltage value in (V).

TABLE 3

| G | 0 | 40 | 160 | 320 | 512 | 700 | 860 | 980 | 1023 |
|---|---|---|---|---|---|---|---|---|---|
| L | 0 | 0.096 | 2.21 | 9.31 | 26.17 | 52.08 | 81.91 | 109.18 | 120 |
| V | 0 | 4.04 | 5.00 | 5.81 | 6.71 | 7.64 | 8.48 | 9.06 | 9.28 |

Subsequently, two adjacent pairs of (L, V) are sequentially selected to perform spline fitting thereon, so as to obtain eight specific function formulas.

As for the brightness value L in the range of [0, 0.096], the gray-scale voltage value V corresponding thereto may be obtained according to the following formula:

V=6.075(L−0)³+33.433(L−0)²+45.262(L−0)+0;

as for the brightness value L in the range of [0.096, 2.21], the gray-scale voltage value V corresponding thereto may be obtained according to the following formula:

V=6.075(L−0.096)³+31.685(L−0.096)²+39.015(L−0.096)+4.04;

as for the brightness value L in the range of [2.21, 9.31], the gray-scale voltage value V corresponding thereto may be obtained according to the following formula:

V=−0.186(L−2.21)³+3.48(L−2.21)²+15.403(L−2.21)+5.00;

as for the brightness value L in the range of [9.31, 26.17], the gray-scale voltage value V corresponding thereto may be obtained according to the following formula:

V=0.014(L−9.31)³−0.571(L−9.31)²+5.790(L−9.31)+5.81;

as for the brightness value L in the range of [26.17, 52.08], the gray-scale voltage value V corresponding thereto may be obtained according to the following formula:

V=−0.002(L−26.17)³+0.121(L−26.17)²−1.790(L−26.17)+6.71:

as for the brightness value L in the range of [52.08, 81.91], the gray-scale voltage value V corresponding thereto may be obtained according to the following formula:

V=0.000435(L−52.08)³−0.030598(L−52.08)²+0.553989(L−52.08)+7.64;

as for the brightness value L in the range of [81.91, 109.18], the gray-scale voltage value V corresponding thereto may be obtained according to the following formula:

V=−0.000128(L−81.91)³+0.00832(L−81.91)²−0.110662(L−81.91)+8.48; and

as for the brightness value L in the range of [109.18, 120], the gray-scale voltage value V corresponding thereto may be obtained according to the following formula:

V=−0.000128(L−109.18)³−0.00212(L−109.18)+0.058263(L−109.18)+9.06;

The curve represented by the above eight function formulas may refer to FIG. 2c.

If a gamma curve needs to be obtained for the maximum brightness value of 100 nit, one may find a solution according to the above function formulas. For example, the calculation result is shown in Table 4. In Table 4, G represents selected gray-scale value, L represents brightness value in (nit), and V represents gray-scale voltage value in (V).

TABLE 4

| G | 0 | 40 | 160 | 320 | 512 | 700 | 860 | 980 | 1023 |
|---|---|---|---|---|---|---|---|---|---|
| L | 0 | 0.08 | 1.68 | 7.76 | 21.81 | 43.40 | 68.26 | 90.99 | 100 |
| V | 0 | 3.41 | 4.87 | 5.81 | 6.40 | 7.43 | 8.10 | 8.70 | 8.88 |

FIG. 2d illustrates gray-scale voltage values, corresponding to the brightness values smaller than or equal to 100 nit, obtained according to the relation curve between gray-scale voltage value and brightness value in the case that the maximum brightness value is 120 nit.

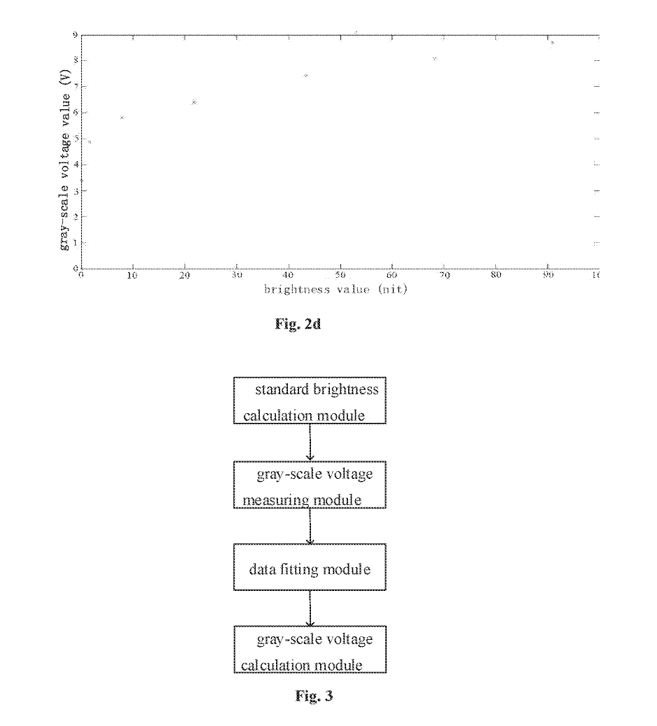

Embodiments of the present invention further provide a gamma curve adjusting device, which, as shown in FIG. 3, includes:

a standard brightness calculation module, used for substituting a preset maximum brightness value, a preset gamma value and gray-scale values into a standard gamma curve calculation formula, to obtain brightness values corresponding to the gray-scale values;

a gray-scale voltage measuring module, used for selecting N gray-scale values from the gray-scale values, and actually measuring, in the condition of the selected N gray-scale values, gray-scale voltage values required to reach the brightness values, respectively corresponding to the selected N gray-scale values, calculated by the standard brightness calculation module, where N is a positive integer;

a data fitting module, used for obtaining a function formula between gray-scale voltage value and brightness value according to the brightness values respectively corresponding to the selected N gray-scale values and the gray-scale voltage values actually measured by the gray-scale voltage measuring module; and

a gray-scale voltage calculation module, used for calculating the gray-scale voltage values corresponding to brightness values smaller than or equal to the preset maximum brightness value, according to the function formula obtained by the data fitting module.

In the embodiments of the present invention, by actually measuring, in the condition of the given maximum brightness value, the gray-scale voltage values corresponding to a set of brightness values (i.e., the brightness values corresponding to the selected set of gray-scale values), and performing data fitting, the function formula between gray-scale voltage value and brightness value is obtained, so that the gray-scale voltage values corresponding to any brightness values smaller than or equal to the given maximum brightness value can be obtained by using the function formula. Therefore, with the gamma curve adjusting device according to the embodiments of the present invention, the time for gamma curve adjustment is significantly shortened while gray-scale voltage accuracy is ensured, and thus production efficiency is improved.

Further, the standard brightness calculation module calculates the brightness values corresponding to the gray-scale values according to the following standard gamma curve calculation formula:

$${L}_{Gray} = {{L}_{max} ( \frac{Gray}{{N}_{{Gray}_{—} max}} )}^{γ}$$

where, N_{gray}_{_}ₘₐₓ is the maximum gray-scale value, Gray is any gray-scale value in the range of [0, N_{gray}_{_}ₘₐₓ], γ is the preset gamma value, Lₘₐₓ is the preset maximum brightness value, and L_{Gray} is the brightness value corresponding to the gray-scale value Gray.

In general, it is quite difficult to realize the above standard gamma curve exactly in a circuit, and an existing method is to select some gray-scale values (generally specified by IC spec) from the above standard gamma curve, and then to adjust the gray-scale voltages corresponding to these selected gray-scale values such that the brightness values corresponding to these selected gray-scale values reach desired brightness values calculated according to the standard gamma curve. In actual test, N is generally greater than or equal to 9. That is to say, the number of the selected gray-scale values is preferably greater than or equal to 9, for example, N may equal to 9, 12, 15, or the like. Within a certain range, the greater N, the higher subsequent fitting accuracy and the better fitting effect.

Further, the data fitting module sequentially selects two adjacent gray-scale values from the N selected gray-scale values, and performs spline fitting on the brightness values and the gray-scale voltage values corresponding to the two adjacent gray-scale values, so as to obtain (N−1) function formulas.

Accordingly, the gray-scale voltage calculation module calculates the gray-scale voltage values corresponding to the brightness values between two brightness values respectively corresponding to the two adjacent gray-scale values, according to the function formula obtained by performing spline fitting on the brightness values and the gray-scale voltage values corresponding to the two adjacent gray-scale values.

In the embodiments of the present invention, the term “performing spline fitting” means performing fitting on two adjacent data pairs by using spline algorithm. Compared with the case where fitting is performed on multiple data pairs simultaneously to obtain one curve, sequentially performing spline fitting on two adjacent data pairs can improve fitting accuracy, and thus ensure accuracy of the gray-scale voltage adjustment to the greatest extent.

Optionally, the (N−1) function formulas may each be a cubic function formula, and the cubic function formula obtained by performing fitting on the brightness values and the gray-scale voltage values corresponding to the n-th selected gray-scale value and the (n+1)-th selected gray-scale value is:

V=a₁ₙ(L−Lₙ)³+a₂ₙ(L−Lₙ)²+a₃ₙ(L−Lₙ)+Vₙ;
where, nε[1, N−1], L is a brightness value in the range of [Lₙ, Lₙ₊₁], Lₙ is the brightness value corresponding to the n-th selected gray-scale value, Lₙ₊₁ is the brightness value corresponding to the (n+1)-th selected gray-scale value, Vₙ is the gray-scale voltage value corresponding to the brightness value Lₙ, V is the gray-scale voltage value corresponding to the brightness value L, and a₁ₙ, a₂ₙ and a₃ₙ are fitting coefficients.

Accordingly, as for a brightness value L in the range of [Lₙ, Lₙ₊₁], the gray-scale voltage value V corresponding thereto is calculated by the gray-scale voltage calculation module according to the above cubic function formula.

In conclusion, the gamma curve adjusting device according to the embodiments of the present invention can achieve quick adjustment of gamma curve, and the time for performing gamma adjusting on each display panel can be shorten during mass production, thereby saving time and improving production efficiency.

It can be understood that, the above implementations are merely exemplary implementations used for explaining the principle of the present invention, but the present invention is not limited thereto. For those skilled in the art, various modifications and improvements may be made without departing from the spirit and essence of the present invention, and these modifications and improvements are also deemed as falling within the protection scope of the present invention.

1. A gamma curve adjusting method, comprising steps of:
substituting a preset maximum brightness value, a preset gamma value and gray-scale values into a standard gamma curve calculation formula, to obtain brightness values corresponding to the gray-scale values;
selecting N gray-scale values from the gray-scale values, and actually measuring, in the condition of the selected N gray-scale values, gray-scale voltage values required to reach the brightness values, respectively corresponding to the selected N gray-scale values, calculated according to the standard gamma curve calculation formula, where N is a positive integer;
obtaining a function formula between gray-scale voltage value and brightness value according to the brightness values respectively corresponding to the selected N gray-scale values and the actually measured gray-scale voltage values; and
calculating the gray-scale voltage values corresponding to brightness values smaller than or equal to the preset maximum brightness value, according to the obtained function formula.

2. The gamma curve adjusting method according to claim 1, wherein, the standard gamma curve calculation formula is:
$${L}_{Gray} = {{L}_{max} ( \frac{Gray}{{N}_{{Gray}_{—} max}} )}^{γ} ;$$
where, N_{Gray}_{_}ₘₐₓ is the maximum gray-scale value, Gray is any gray-scale value in the range of [0, N_{Gray}_{_}ₘₐₓ], γ is the preset gamma value, Lₘₐₓ is the preset maximum brightness value, and L_{Gray} is the brightness value corresponding to the gray-scale value Gray.

3. The gamma curve adjusting method according to claim 1, wherein, the step of obtaining a function formula between gray-scale voltage value and brightness value according to the brightness values respectively corresponding to the selected N gray-scale values and the actually measured gray-scale voltage values comprises:
sequentially selecting two adjacent gray-scale values from the N selected gray-scale values and performing spline fitting on the brightness values and the gray-scale voltage values corresponding to the two adjacent gray-scale values, to obtain (N−1) function formulas; and
the step of calculating the gray-scale voltage values corresponding to brightness values smaller than or equal to the preset maximum brightness value, according to the obtained function formula comprises:
calculating the gray-scale voltage values corresponding to the brightness values between two brightness values respectively corresponding to the two adjacent gray-scale values, according to the function formula obtained by performing spline fitting on the brightness values and the gray-scale voltage values corresponding to the two adjacent gray-scale values.

4. The gamma curve adjusting method according to claim 3, wherein, the (N−1) function formulas each are a cubic function formula, and the cubic function formula obtained by performing fitting on the brightness values and the gray-scale voltage values corresponding to the n-th selected gray-scale value and the (n+1)-th selected gray-scale value is:
V=a₁ₙ(L−Lₙ)³+a₂ₙ(L−Lₙ)²+a₃ₙ(L−Lₙ)+Vₙ;
where, nε[1, N−1], L is a brightness value in the range of [Lₙ, Lₙ₊₁], Lₙ is the brightness value corresponding to the n-th selected gray-scale value, Lₙ₊₁ is the brightness value corresponding to the (n+1)-th selected gray-scale value, Vₙ is the gray-scale voltage value corresponding to the brightness value Lₙ, V is the gray-scale voltage value corresponding to the brightness value L, and a₁ₙ, a₂ₙ and a₃ₙ are fitting coefficients; and
as for the brightness value in the range of [Lₙ, Lₙ₊₁], the gray-scale voltage value corresponding thereto is calculated according to the cubic function formula.

5. The gamma curve adjusting method according to claim 1, wherein, N≧9.

6. The gamma curve adjusting method according to claim 2, wherein, N≧9.

7. The gamma curve adjusting method according to claim 3, wherein, N≧9.

8. The gamma curve adjusting method according to claim 4, wherein, N≧9.

9. The gamma curve adjusting method according to claim 4, wherein, N=9;
the cubic function formula obtained by performing fitting on the brightness values and the gray-scale voltage values corresponding to the first and second selected gray-scale values is:
V=a₁₁(L−L₁)³+a₂₁(L−L₁)²+a₃₁(L−L₁)+V₁ (1-1)
as for the brightness value L in the range of [L₁, L₂], the gray-scale voltage value V corresponding thereto is calculated according to the cubic function formula (1-1), where L₁ and L₂ are the brightness values corresponding to the first and second selected gray-scale values, respectively, V₁ is the gray-scale voltage value corresponding to the first selected gray-scale value, and a₁₁, a₂₁ and a₃₁ are fitting coefficients of the cubic function formula (1-1);
the cubic function formula obtained by performing fitting on the brightness values and the gray-scale voltage values corresponding to the second and third selected gray-scale values is:
V=a₁₂(L−L₂)³+a₂₂(L−L₂)²+a₃₂(L−L₂)+V₂ (1-2)
as for the brightness value L in the range of [L₂, L₃], the gray-scale voltage value V corresponding thereto is calculated according to the cubic function formula (1-2), where L₂ and L₃ are the brightness values corresponding to the second and third selected gray-scale values, respectively, V₂ is the gray-scale voltage value corresponding to the second selected gray-scale value, and a₁₂, a₂₂ and a₃₂ are fitting coefficients of the cubic function formula (1-2);
the cubic function formula obtained by performing fitting on the brightness values and the gray-scale voltage values corresponding to the third and fourth selected gray-scale values is:
V=a₁₃(L−L₃)³+a₂₃(L−L₃)²+a₃₃(L−L₃)+V₃ (1-3)
as for the brightness value L in the range of [L₃, L₄], the gray-scale voltage value V corresponding thereto is calculated according to the cubic function formula (1-3), where L₃ and L₄ are the brightness values corresponding to the third and fourth selected gray-scale values, respectively, V₃ is the gray-scale voltage value corresponding to the third selected gray-scale value, and a₁₃, a₂₃ and a₃₃ are fitting coefficients of the cubic function formula (1-3);
the cubic function formula obtained by performing fitting on the brightness values and the gray-scale voltage values corresponding to the fourth and fifth selected gray-scale values is:
V=a₁₄(L−L₄)³+a₂₄(L−L₄)²+a₃₄(L−L₄)+V₄ (1-4)
as for the brightness value L in the range of [L₄, L₅], the gray-scale voltage value V corresponding thereto is calculated according to the cubic function formula (1-4), where L₄ and L₅ are the brightness values corresponding to the fourth and fifth selected gray-scale values, respectively, V₄ is the gray-scale voltage value corresponding to the fourth selected gray-scale value, and a₁₄, a₂₄ and a₃₄ are fitting coefficients of the cubic function formula (1-4);
the cubic function formula obtained by performing fitting on the brightness values and the gray-scale voltage values corresponding to the fifth and sixth selected gray-scale values is:
V=a₁₅(L−L₅)³+a₂₅(L−L₅)²+a₃₅(L−L₅)+V₅ (1-5)
as for the brightness value L in the range of [L₅, L₆], the gray-scale voltage value V corresponding thereto is calculated according to the cubic function formula (1-5), where L₅ and L₆ are the brightness values corresponding to the fifth and sixth selected gray-scale values, respectively, V₅ is the gray-scale voltage value corresponding to the fifth selected gray-scale value, and a₁₅, a₂₅ and a₃₅ are fitting coefficients of the cubic function formula (1-5);
the cubic function formula obtained by performing fitting on the brightness values and the gray-scale voltage values corresponding to the sixth and seventh selected gray-scale values is:
V=a₁₆(L−L₆)³+a₂₆(L−L₆)²+a₃₆(L−L₆)+V₆ (1-6)
as for the brightness value L in the range of [L₆, L₇], the gray-scale voltage value V corresponding thereto is calculated according to the cubic function formula (1-6), where L₆ and L₇ are the brightness values corresponding to the sixth and seventh selected gray-scale values, respectively, V₆ is the gray-scale voltage value corresponding to the sixth selected gray-scale value, and a₁₆, a₂₆ and a₃₆ are fitting coefficients of the cubic function formula (1-6);
the cubic function formula obtained by performing fitting on the brightness values and the gray-scale voltage values corresponding to the seventh and eighth selected gray-scale values is:
V=a₁₇(L−L₇)³+a₂₇(L−L₇)²+a₃₇(L−L₇)+V₇ (1-7)
as for the brightness value L in the range of [L₇, L₈], the gray-scale voltage value V corresponding thereto is calculated according to the cubic function formula (1-7), where L₇ and L₈ are the brightness values corresponding to the seventh and eighth selected gray-scale values, respectively, V₇ is the gray-scale voltage value corresponding to the seventh selected gray-scale value, and a₁₇, a₂₇ and a₃₇ are fitting coefficients of cubic function the formula (1-7); and
the cubic function formula obtained by performing fitting on the brightness values and the gray-scale voltage values corresponding to the eighth and ninth selected gray-scale values is:
V=a₁₈(L−L₈)³+a₂₈(L−L₈)²+a₃₈(L−L₈)+V₈ (1-8)
as for the brightness value L in the range of [L₈, L₉], the gray-scale voltage value V corresponding thereto is calculated according to the cubic function formula (1-8), where L₈ and L₉ are the brightness values corresponding to the eighth and ninth selected gray-scale values, respectively, V₈ is the gray-scale voltage value corresponding to the eighth selected gray-scale value, and a₁₈, a₂₈ and a₃₈ are fitting coefficients of the cubic function formula (1-8).

10. A gamma curve adjusting device, comprising:
a standard brightness calculation module, used for substituting a preset maximum brightness value, a preset gamma value and gray-scale values into a standard gamma curve calculation formula, to obtain brightness values corresponding to the gray-scale values;
a gray-scale voltage measuring module, used for selecting N gray-scale values from the gray-scale values, and actually measuring, in the condition of the selected N gray-scale values, gray-scale voltage values required to reach the brightness values, respectively corresponding to the selected N gray-scale values, calculated by the standard brightness calculation module, where N is a positive integer;
a data fitting module, used for obtaining a function formula between gray-scale voltage value and brightness value according to the brightness values respectively corresponding to the selected N gray-scale values and the gray-scale voltage values actually measured by the gray-scale voltage measuring module; and
a gray-scale voltage calculation module, used for calculating the gray-scale voltage values corresponding to brightness values smaller than or equal to the preset maximum brightness value, according to the function formula obtained by the data fitting module.

11. The gamma curve adjusting device according to claim 10, wherein, the standard brightness calculation module calculates the brightness values corresponding to the gray-scale values according to the following standard gamma curve calculation formula:
$${L}_{Gray} = {{L}_{max} ( \frac{Gray}{{N}_{{Gray}_{—} max}} )}^{γ}$$
where, N_{Gray}_{_}ₘₐₓ is the maximum gray-scale value, Gray is any gray-scale value in the range of [0, N_{Gray}_{_}ₘₐₓ], γ is the preset gamma value, Lₘₐₓ is the preset maximum brightness value, and L_{Gray} is the brightness value corresponding to the gray-scale value Gray.

12. The gamma curve adjusting device according to claim 10, wherein, the data fitting module sequentially selects two adjacent gray-scale values from the N selected gray-scale values and performs spline fitting on the brightness values and the gray-scale voltage values corresponding to the two adjacent gray-scale values, to obtain (N−1) function formulas; and
the gray-scale voltage calculation module calculates the gray-scale voltage values corresponding to the brightness values between two brightness values respectively corresponding to the two adjacent gray-scale values, according to the function formula obtained by performing spline fitting on the brightness values and the gray-scale voltage values corresponding to the two adjacent gray-scale values.

13. The gamma curve adjusting device according to claim 12, wherein, the (N−1) function formulas each are a cubic function formula, and the cubic function formula obtained by performing fitting on the brightness values and the gray-scale voltage values corresponding to the n-th selected gray-scale value and the (n+1)-th selected gray-scale value is:
V=a₁ₙ(L−Lₙ)³+a₂ₙ(L−Lₙ)²+a₃ₙ(L−Lₙ)+Vₙ;
where, nε[1, N−1], L is a brightness value in the range of [Lₙ, Lₙ₊₁], Lₙ is the brightness value corresponding to the n-th selected gray-scale value, Lₙ₊₁ is the brightness value corresponding to the (n+1)-th selected gray-scale value, Vₙ is the gray-scale voltage value corresponding to the brightness value Lₙ, V is the gray-scale voltage value corresponding to the brightness value L, and a₁ₙ, a₂ₙ and a₃ₙ are fitting coefficients; and
as for the brightness value L in the range of [Lₙ, Lₙ₊₁], the gray-scale voltage value V corresponding thereto is calculated by the gray-scale voltage calculation module according to the cubic function formula.
